(19) United States
(12) Patent Application Publication
(10) Pub. No.: US 2025/0341817 A1
(43) Pub. Date: Nov. 6, 2025

(54) KIRIGAMI-BASED PLATFORM FOR SHAPE PROGRAMMABLE AND STRETCH CONTROLLABLE APPLICATIONS

(71) Applicant: Northwestern University, Evanston, IL (US)

(72) Inventors: Horacio Dante Espinosa, Evanston, IL (US); Nicolas Alejandro Alderete, Evanston, IL (US)

(21) Appl. No.: 19/194,271

(22) Filed: Apr. 30, 2025

Related U.S. Application Data
(60) Provisional application No. 63/641,090, filed on May 1, 2024.

(51) Int. Cl. G05B 19/4093

(52) U.S. Cl. CPC G05B 19/40935; G05B 2219/45031

(57) ABSTRACT

In an aspect, a Kirigami motif includes a substrate including a plane. The Kirigami motif includes inner panels defined by geometric cuts disposed through the substrate. The geometric cuts include fixed geometric parameters. The substrate is configured for controlled actuation in-plane, with respect to the plane, to control out-of-plane deformation of the inner panels.

STATEMENT OF FEDERALLY FUNDED RESEARCH OR SPONSORSHIP

The present application claims the benefit of priority under 35 U.S.C. § 119 from U.S. Provisional Patent Application Ser. No. 63/641,090 entitled “Kirigami-based Platform for Shape Programmable and Stretch Controllable Applications,” filed on, the disclosure of which is hereby incorporated by reference in its entirety for all purposes.

### STATEMENT OF FEDERALLY FUNDED RESEARCH OR SPONSORSHIP

This invention was made with government support under grant number FA9550-20-1-0258 awarded by the Department of Defense, Department of the Air Force, and the Air Force Office of Scientific Research and under grant number CMMI-1953806 awarded by the National Science Foundation. The government has certain rights in the invention.

### TECHNICAL FIELD

The present disclosure generally relates to versatile planar platforms, and more specifically relates to versatile planar platforms based on Kirigami-engineering that enables programmable, controllable, and multimodal 2D-to-3D shape transformations.

### BACKGROUND

In the present context of a spate of mechanical metamaterials, Kirigami has successfully carved out a niche within the subclass of surface-based shape-programmable metamaterials. Its emergence and establishment as a frontrunner platform for shape-morphability is due in no small part to its rich and complex landscape of 2D and 3D deformations that stem from a contrasting simplicity in geometry (e.g., single-slit motifs), manufacturing (e.g., laser cutting, FIB), and actuation modality (e.g., in-plane tension). Kirigami's geometrical simplicity, must however be understood in global motif terms, which quickly becomes intractable if the number of geometric combinations within a single motif is thoroughly considered. As such, a significant portion of Kirigami research has been devoted to unravelling the space of shapes resulting from constrained combinations of geometrical parameters. The discovery of Kirigami's shape-morphing capabilities coupled with inverse-design techniques has led to a plethora of applications ranging from, for example, grippers, friction surfaces, optical-surfaces, and protective systems.

The description provided in the background section should not be assumed to be prior art merely because it is mentioned in or associated with the background section. The background section may include information that describes one or more aspects of the subject technology.

### BRIEF DESCRIPTION OF DRAWINGS

The disclosure is better understood with reference to the following drawings and description. The elements in the figures are not necessarily to scale, emphasis instead being placed upon illustrating the principles of the disclosure. Moreover, in the figures, like-referenced numerals may designate to corresponding parts throughout the different views.

FIG. 1A illustrates an exemplary Kirigami motif and responses under in-plane normal and tangential tractions.

FIG. 1B illustrates an exemplary X-Asymmetric Kirigami for shear modes.

FIG. 1C illustrates an exemplary Y-Asymmetric Kirigami for shear modes.

FIG. 2A illustrates an exemplary tabletop shear-tension setup depicting a Kirigami sample with a dot where a laser is focused along with a completely painted Kirigami sample for shadow moiré imaging, according to certain aspects of the present disclosure.

FIG. 2B illustrates an exemplary laser-cut Kirigami sample with detailed views, according to certain aspects of the present disclosure.

FIG. 3A illustrates an X-Asymmetric Kirigami Meta-Atom and bifurcation curves in terms of the a₃/a₁ ratio, according to certain aspects of the present disclosure.

FIG. 3B illustrates a series of select bifurcation curves with respect to shear strain on the X-Asymmetric Kirigami Meta-Atom of FIG. 3A, according to certain aspects of the present disclosure.

FIG. 3C illustrates a diagram depicting influence of shear load direction on final deformation, according to certain aspects of the present disclosure.

FIG. 3D illustrates a series of charts depicting mode-coupling and iso-displacement lines for select cases of the X-Asymmetric Kirigami Meta-Atom of FIG. 3A, according to certain aspects of the present disclosure.

FIG. 3E illustrates a chart depicting comparison of in-plane shear and in-plane tension activated X-Asymmetric Kirigami, according to certain aspects of the present disclosure.

FIG. 3F illustrates a diagram depicting comparison of in-plane shear and in-plane tension activated X-Asymmetric Kirigami, according to certain aspects of the present disclosure.

FIG. 4A illustrates an Y-Asymmetric Kirigami Meta-Atom and bifurcation curves in terms of the a₃/a₁ ratio, according to certain aspects of the present disclosure.

FIG. 4B illustrates a series of select bifurcation curves with respect to shear strain on the Y-Asymmetric Kirigami Meta-Atom of FIG. 4A, according to certain aspects of the present disclosure.

FIG. 4C illustrates a diagram depicting influence of shear load direction on final deformation, according to certain aspects of the present disclosure.

FIG. 4D illustrates a series of charts depicting mode-coupling and iso-displacement lines for select cases of the Y-Asymmetric Kirigami Meta-Atom of FIG. 4A, according to certain aspects of the present disclosure.

FIG. 4E illustrates a chart depicting comparison of in-plane shear and in-plane tension activated Y-Asymmetric Kirigami, according to certain aspects of the present disclosure.

FIG. 4F illustrates a diagram depicting comparison of in-plane shear and in-plane tension activated Y-Asymmetric Kirigami, according to certain aspects of the present disclosure.

FIG. 5A illustrates a diagram depicting comparison of moiré interferograms and numerically obtained out-of-plane displacement contours for X-Asymmetric Kirigami, according to certain aspects of the present disclosure.

FIG. 5B illustrates a diagram depicting comparison of moiré interferograms and numerically obtained out-of-plane displacement contours for Y-Asymmetric Kirigami, according to certain aspects of the present disclosure.

FIG. 5C illustrates a diagram depicting comparison of out-of-plane displacement measurement at a single point with numerical prediction for Y-Asymmetric Kirigami with mode jump, according to certain aspects of the present disclosure.

FIG. 6A illustrates a diagram depicting application of X-Asymmetric Kirigami in a Tri-State switch, according to certain aspects of the present disclosure.

FIG. 6B illustrates a diagram depicting application of Y-Asymmetric Kirigami in a Dual-State switch with delay, according to certain aspects of the present disclosure.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below is intended as a description of various implementations and is not intended to represent the only implementations in which the subject technology may be practiced. As those skilled in the art would realize, the described implementations may be modified in various different ways, all without departing from the scope of the present disclosure. Accordingly, the drawings and description are to be regarded as illustrative in nature and not restrictive.

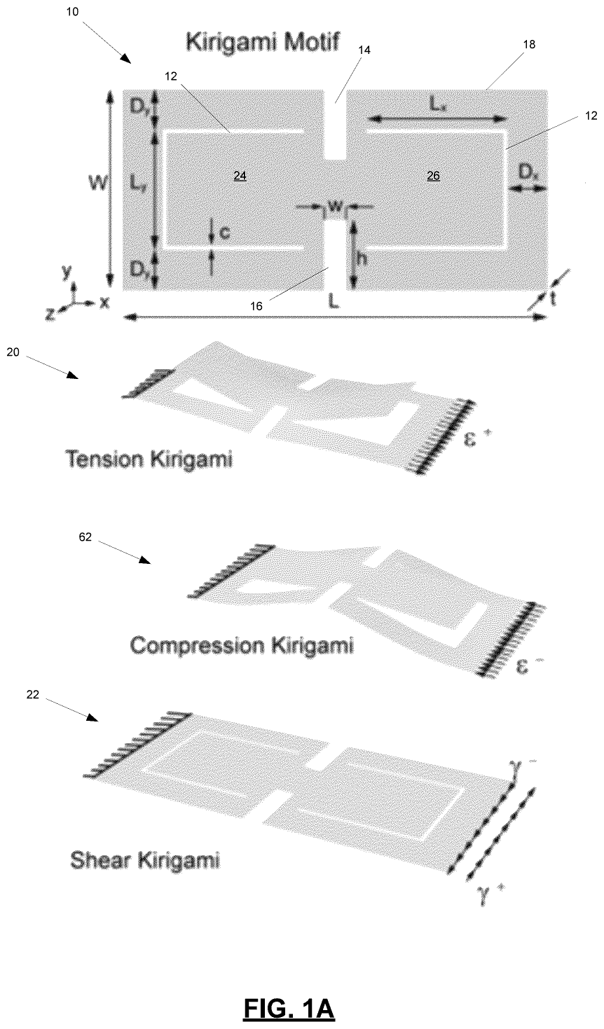

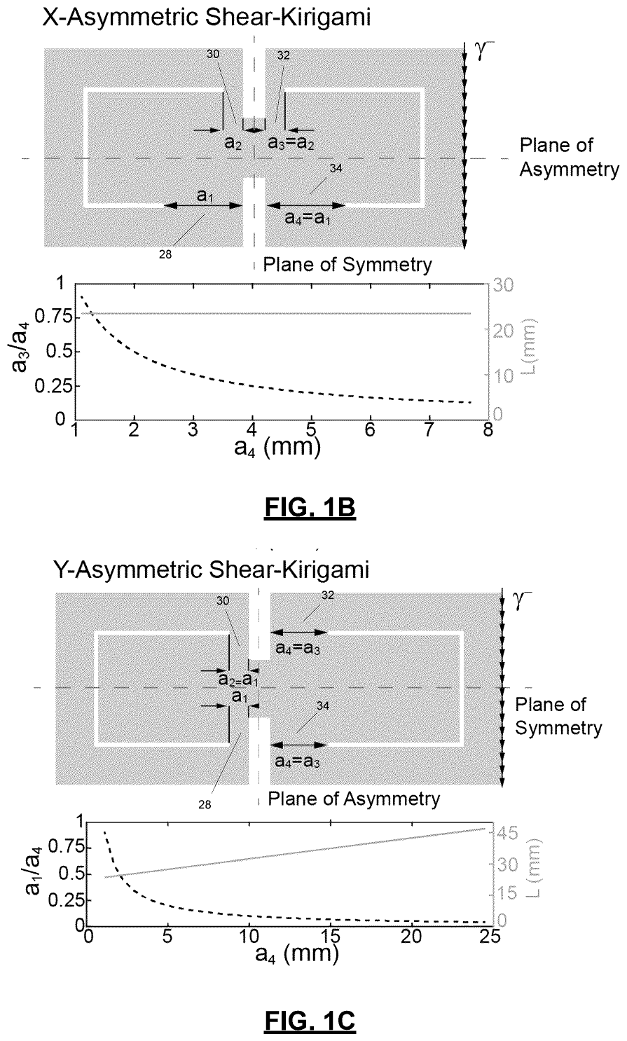

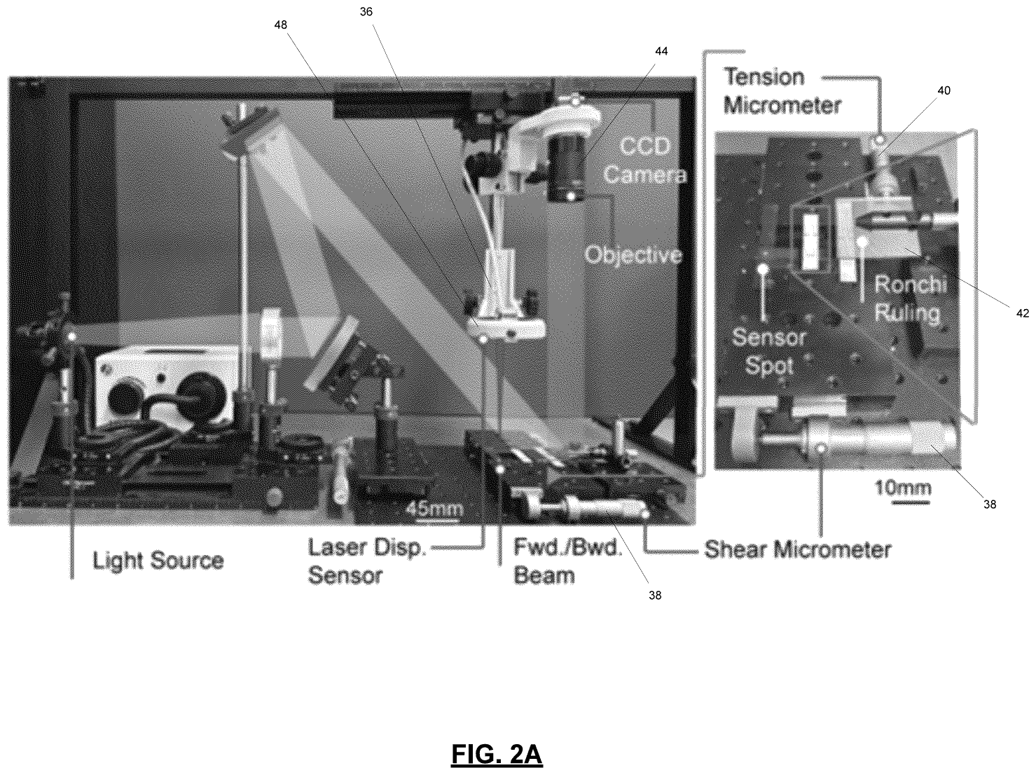

Kirigami's unique behavior has been primarily examined under in-plane stretching, leaving aside other fundamental loading modes like shear, bending, and torsion. The handful of articles dealing with shear-Kirigami have focused on its flexibility and stress-strain behavior properties, and more recently in the use of shear to promote origami-kirigami-type self-foldability. Said paucity is not unique to Kirigami-type systems, but is true even for other classes of mechanical metamaterials, where shear-actuated ones seem less prevalent than their tension/compression activated counterparts. Shear loading, in particular, offers an intriguing platform for Kirigami actuation because it can be applied in-plane (i.e., like tension), it is known to trigger buckling instabilities in ribbons and plates, it offers loading directionality (i.e., positive/negative shear) without compromising Kirigami phenomena (i.e., tension cannot be reversed to compression whilst preserving Kirigami behavior, see FIG. 1A), and because shear-loading is ubiquitous in the mechanical world (e.g., friction, ground-motion, musculoskeletal motion, etc.) directly implying that harnessing shear can be exploited in a range of applications. As such, mapping out the mechanical response of Kirigami cells under simple shear could open an opportunity for the development of intelligent multimodal metamaterials, with markedly distinct responses under distinct loadings.

Directly addressing the aforementioned research gap, the disclosed technology combines nonlinear finite element analysis with tabletop experiments to quantify the mechanical response and map the out-of-plane bifurcations of a set of Kirigami meta-atoms with a common motif subject to geometrical asymmetries and in-plane shear loading. The disclosed technology demonstrates that tapping into the shear regime not only adds to the already rich set of behaviours offered by these materials in tension but extends it by displaying properties insofar unobserved in the stretching regime.

In certain aspects, the disclosed technology provides a platform based on a particular Kirigami motif (i.e., a rectangular sheet, with two c-shaped cuts separated by two vertical notches), and variations thereof, that can be actuated in a variety of loading modalities to enable and control 2D-to-3D shape transformations. The platform leverages mechanical instabilities that trigger out-of-plane deformations when a planar thin sheet embedded with specific cuts is actuated in-plane. Variation of the geometrical parameters that define the Kirigami motif allows for programmable out-of-plane deformation modes with symmetric and anti-symmetric characteristics. Controlled actuation of the motif under fundamental in-plane loading modes (i.e., tension, shear), in static or dynamic conditions (i.e., monotonic, pulsating), allows for control of the out-of-plane deformation and deformation regime selection (i.e., undeformed, primary mode, mode jumps). The Kirigami motif can be used in single-atom (i.e., standalone), or multi-atom (i.e., 1D, 2D, 3D arrays) configurations for extended applicability. Importantly, the Kirigami platform is suitable for rational inverse design, via topology optimization or machine learning approaches, which makes it an apt candidate for engineering applications.

The disclosed technology advantageously provides a spectrum of designable, programmable, and controllable shape-transformations contained within a single realization of the Kirigami-motif, regardless of the spatial scale and the material constituent. As such, the versatility of the platform enables a plethora of technical and non-technical applications where on-demand 2D-to-3D shape-morphability is a requirement.

The shape-programmable nature of the motif is first uncovered at the nanoscale leveraging the residual stresses resulting from the cutting of the Kirigami motif on SiNx substrates with focused ion beam technology. Replacing residual stresses with controlled stretching, the controllable nature of the mechanical bifurcations governing the shape-transformations is demonstrated at the macroscale in paper-based Kirigami cells. A first set of applications is devised and explored computationally. The rational designability of the shape transformations by tensile loading is established using physics-based machine learning methods and experimental validation techniques, which included proof-of-concept demonstrations of a number of bioinspired applications. Extension of the concept to in-plane shear loading and pulsating dynamic loads is within the scope of the present disclosure, also with demonstrations of a number of potential applications.

As discussed above, in certain aspects, the disclosed technology provides a Kirigami-based platform characterized by intricate geometric cuts on a thin rectangular substrate, aimed at inducing controlled three-dimensional out-of-plane deformations ideally suited for various applications. The platform utilizes C-shaped cuts separated by vertical notches, that define two inner panels capable of localizing a variety out-of-plane deformation upon activation. Various actuation modalities, which include in-plane stretch, shear, and dynamic loading, augment the available design and output space for shape-morphing. Beyond the single Kirigami unit, the technology can be easily architected at variety of spatial scales into 1D, 2D and even 3D arrays, for complex applications. Furthermore, the proven, rational designability and controllability of these mechanical units make them good candidates for engineering applications that require precision and accuracy. All in all, the variegated nature of the design space makes this platform ideally suited for a plethora of applications where shape-morphability, multitasking, and space-saving are of critical importance. The disclosed technology can be utilized in various applications including, but not limited to, light-steering/collection/diffusion devices, solar sails, active surfaces for friction and drag control, multi-state electromechanical switches, mechanical amplifiers, sensors, and actuators. The simplicity in the geometry also makes them good candidates for functionalized substrates, where functional elements can be added to the Kirigami system to leverage their shape-morphability.

In certain aspects, the disclosed technology demonstrates the effect of geometry and in-plane shear loading in the Kirigami motif 10 depicted in FIG. 1A. The motif 10 exhibits a pair of C-shaped cuts (characterized by fixed geometrical parameters c, Lₓ, L_{y}), such as a first C-shaped cut 12 and a second C-shaped cut 13, separated by two vertical cuts (characterized by fixed geometrical parameters h, w), such as a first vertical cut 14 and a second vertical cut 16, embedded in a flat, thin sheet 18 with fixed characteristic dimensions Dₓ, D_{y}, W, t. Selection of the motif 10 responds to a number of reasons. First, the established landscape and versatility of the motif 10 under a tension mode 20 offers a direct counterpoint to the premise of an augmented design space by incorporation of shear actuation (e.g., shear mode 22). Second, the geometrical simplicity of both the motif 10 and its shape-morphability makes it a versatile element to design with, aggregate (i.e., 1D, 2D, 3D arrays), and manufacture for applications. In this sense, the motif 10 has been shown to enable a host of applications where the deformation of the inner panels (e.g., first inner panel 24 and second inner panel 26) can be leveraged in standalone fashion (e.g., grippers, solid deflectors) or in functionalized substrate mode (i.e., with functional elements or coatings mounted on the plates).

With reference to FIGS. 1B and 1C, geometrical variations of the motif 10 are considered here only in terms of the length of the hinges (e.g., first hinge 28, second hinge 30, third hinge 32, and fourth hinge 34) that is, the distance between the vertical cuts and the arms of the C-shaped cuts 12, 13 (characterized by geometrical parameters a₁, a₂, a₃, a₄, respectively). Specifically, two subsets of the variations are studied: Variations of hinges asymmetrical with respect to the X-Axis (see FIG. 1B) and variations asymmetrical with respect to the Y-axis (see FIG. 1C). While the latter configuration explores the effect of asymmetry of the motif 10 alone (i.e., shear direction irrelevant), the former is intended to uncover the interplay between the geometric asymmetry and the loading direction (i.e., positive and negative shear). Note that variation of the hinge lengths (e.g., a₁, a₂, a₃, a₄) as defined above implies that X-Asymmetric motifs have the same meta-atom length, while Y-Asymmetric meta-atoms change length. The values adopted for the geometrical description of the motif are summarized in Table 1 below.

| Cases | Geometrical Parameter | Dimension (mm) |
|---|---|---|
| All Cases | C-Cut Kerf (c) | 0.2 |
| | C-Cut Height (L_{y}) | 6.0 |
| | C-Cut Length (Lₓ) | 7.0 |
| | U-Cut Kerf (w) | 1.1 |
| | U-Cut Height (h) | 3.5 |
| | Vertical Margins (D_{y}) | 2.0 |
| | Horizontal Margins (Dₓ) | 2.0 |
| | Sheet Length (L) | 2Dₓ + 2Lₓ + h + a₁ + a₃ |
| | Sheet Width (W) | 10.0 |
| | Sheet Thickness (t) | 0.0762 (3 mil) |
| X-Asymmetric | Hinge Length (a₁ = a₄) | [1.0:0.1:7.7] |
| Cases | Hinge Length (a₂ = a₃) | 1.0 |
| Y-Asymmetric | Hinge Length (a₁ = a₂) | 1.0 |
| Cases | Hinge Length (a₃ = a₄) | [1.0:0.1:25.0] |

The mechanical response of the example Kirigami motif 10 is first investigated using finite element analysis. Finite element analysis is employed here because analytical formulations for this type of Kirigami geometry are currently unavailable. First, a linear buckling analysis is performed imposing a unit displacement along the Y-Direction on the nodes of one of the Kirigami motif 10 short edges, while keeping the other corresponding edge fixed. Using the Lanczos solution scheme (*BUCKLE, EIGENSOLVER=LANCZOS), the first six eigenvalues are calculated allowing computation of pairs of positive and negative eigenvalues (i.e., critical shear displacement in the positive and negative shear directions). Visual inspection of the displacements is conducted to assess differences between the eigen-solutions of the positive and negative shear displacements. Following the linear buckling analysis, the post-buckling regime is probed under geometrically nonlinear analysis conditions (*NLGEOM), subjecting the Kirigami motif 10 meta-atom to a displacement δ_{Y}=2t in the global Y-Direction. The first relevant eigenmode from the linear buckling analysis step is employed as geometric imperfection. Upon completion of the analysis, the out-of-plane displacements of the centerline chords are collected, together with the reaction forces of the constrained nodes and the vertical displacement of a tracker node from which force-displacement, and bifurcation curves are constructed. Relevant strain measures for shear (e.g., shear mode 22) and tension (e.g., tension mode 20) are calculated using engineering strains (i.e., γ=δ_{Y}/L, ε=δ_{X}/L, where δ_{Y} and δ_{X} are the corresponding in-plane displacements, and L is the length of the Kirigami motif 10 unit). The aforesaid sequence is implemented with an in-house developed script, such as, for example, an Abaqus-Python script, to allow for the automated parametric sweep of the geometric parameters considered. In all cases, mapped quadrilateral meshes with first order shell elements are used (S4R). Mesh convergence analysis is performed in a preliminary stage, observing no significant differences beyond an element size of Δ_{FE}=0.01 mm. Kapton film is used as representative material, with elastic isotropic material properties (E=2.5 GPa, v=0.34).

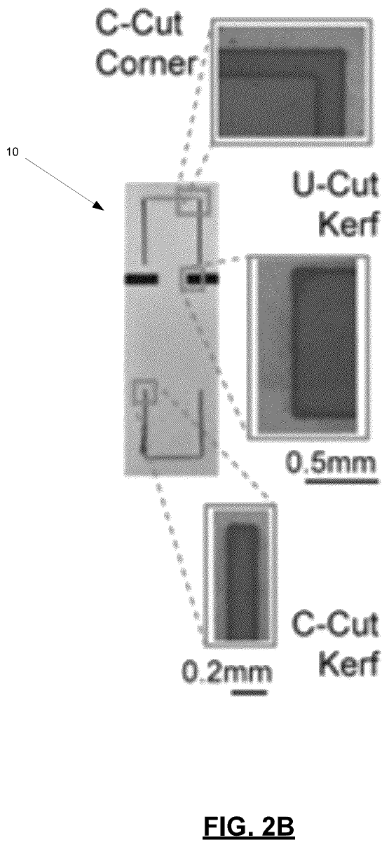

Referring to FIG. 2A, a selection of Kirigami motif 10 meta-atoms are chosen based on the relevance of their structural behavior. The selected motifs are drawn in a 3D CAD design program such as, for example, Solidworks 2021, and exported to a format suitable for interpretation by a laser cutter 36, such as, for example, the LPKF Protolaser R Laser Cutter. As opposed to conventional laser cutters, ablation laser cutters like the LPKF Protolaser R, produce an almost immediate evaporation of the material directly beneath the laser spot, thus minimizing heat transfer. Based on previous experience, laser power is optimized based on the substrate material and thickness to allow for complete through-the-thickness cutting and minimal residual warping. In certain examples, samples are cut from Kapton HN300 sheets.

Shear testing is performed on the fabricated samples using two manual, micrometer-controlled (step of 5 μm), linear stages (e.g. shear micrometer 38). The stages are crossed with respect to one another, enabling tension control and shear control of the Kirigami samples (e.g., Kirigami motif 10). Following fixing of the Kirigami samples, the tension stage (via tension micrometer 40) is used to carefully remove any possible slack introduced during the positioning and clamping operations. Out-of-plane displacements of the buckled configurations are characterized in two-ways. On the one hand, buckling mode shapes of the entire meta-atom are mapped using the shadow moiré technique, in a normal observation configuration. To such end, a glass 42, such as, for example, a Ronchi Ruling of 100 line-pairs per inch, is placed at a distance of 2 mm before the specimens, and images are taken with a camera 44, such as, for example, a monochrome Mako U-503B CCD Camera. Due to the inherent transparency of the Kapton films, a thin coating of white gesso is sprayed onto the samples for shadow and fringe contrast. On the other hand, point-wise measurements of out-of-plane deflections are conducted using a displacement sensor 46, such as, for example, an Acuity AR100-100 super compact laser displacement sensor. The red laser sensor 48 (660 nm wavelength) is positioned vertically above the panel location of interest, which allows for accurate measurement of the distance from the panel to the fixed laser (0.01% resolution and 0.05% linearity of the full-scale range (100 mm), 9.4 kHz sampling rate). To ensure proper reflection, and minimal interference with the sample response, only a single small white dot is painted at the locations of interest. Output from the laser is via an R232 connector directly to the PC (not shown) and read using, for example, Matlab R2022b Instrument Control Toolbox. The shear loading is manually applied in increments of 5μm, up to a final imposed displacement several multiples beyond the bifurcation point. The tabletop setup implemented is shown in FIG. 2A together with the different elements described above both for imaging the deformation and for imposing the deformation.

FIG. 2B illustrates an exemplary laser-cut Kirigami sample (e.g., Kirigami motif 10) with detailed views of a C-cut corner, a U-cut kerf, and a C-cut kerf.

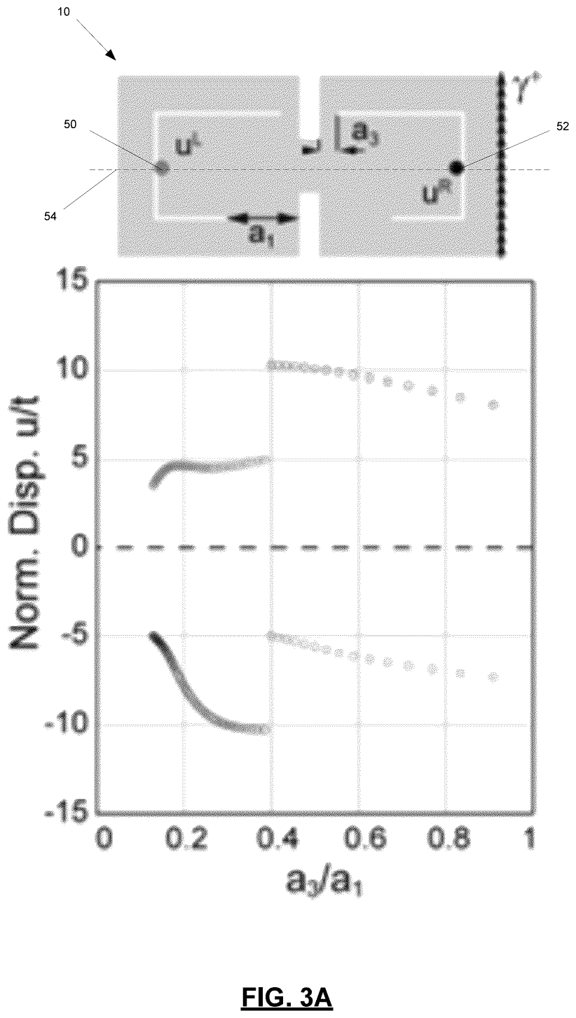

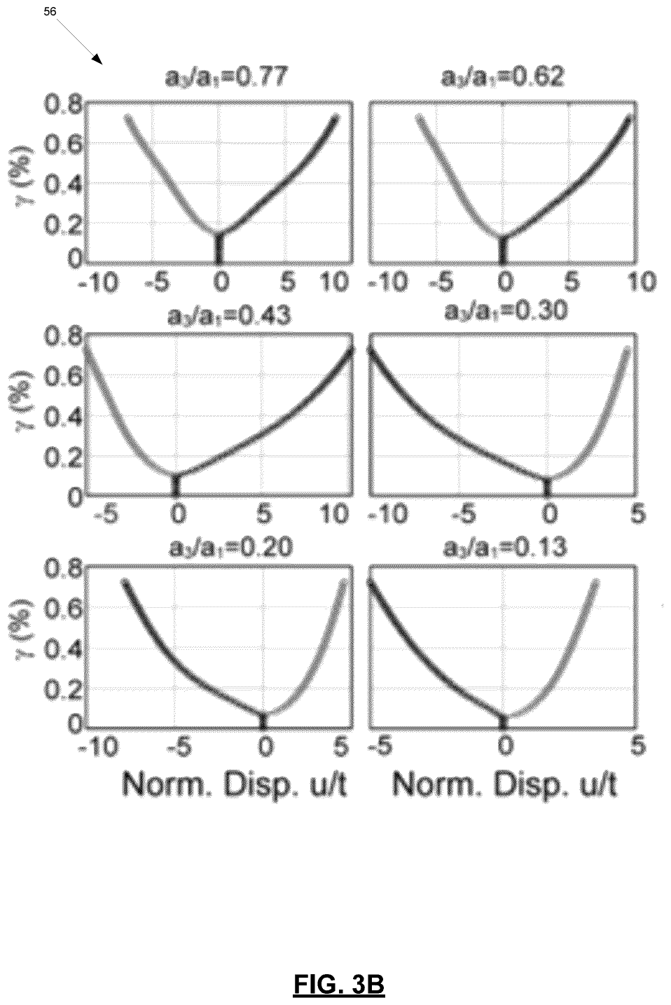

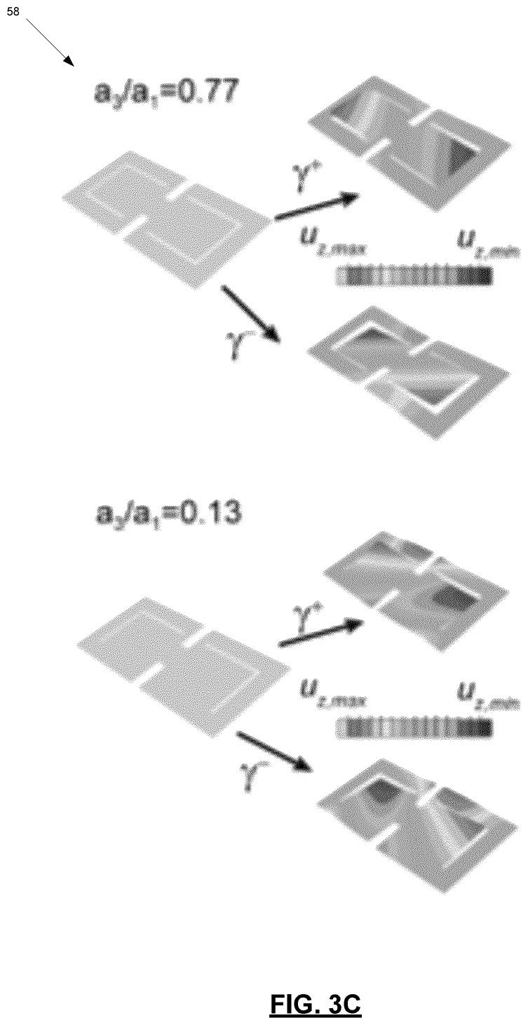

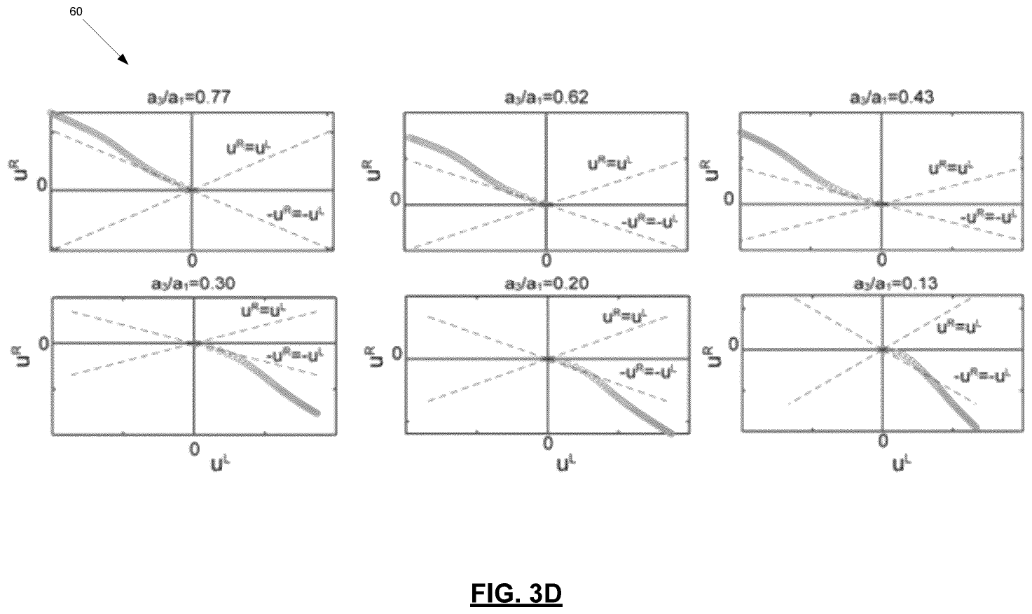

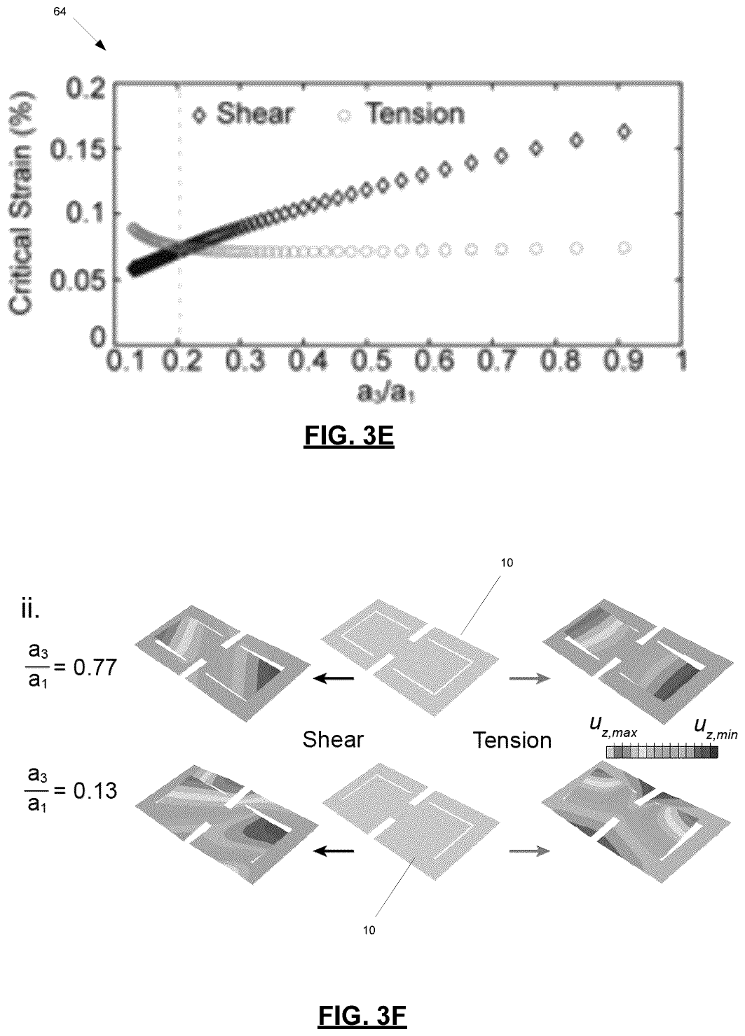

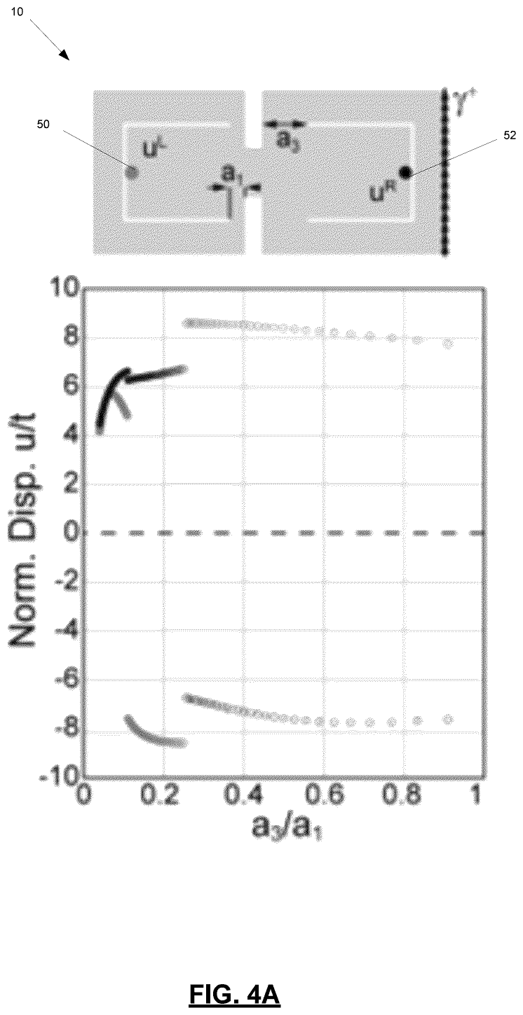

FIGS. 3A-3F summarize the most relevant results, from a perspective of shape-morphability, obtained by finite element simulations of the example Kirigami motifs (e.g., the Kirigami motif 10) with X-Asymmetric motif. The disclosed technology begins by comparing the panels' (e.g., the first inner panel 24 and the second inner panel 26) final out-of-plane displacements measured at two-gauge points (e.g., first gauge point 50 and second gauge point 52) along the Kirigami's central chord 54, one in each panel (labelled u^{L} and u^{R} for convenience) as shown in FIG. 3A. While bifurcations could be studied for any nodes within the panels (e.g., the first inner panel 24 and the second inner panel 26), selection of the extreme-center nodes allow for a balanced comparison with other asymmetric variations of the motif 10 (i.e., as opposed to choosing panel corner nodes that may have a stronger influence of the horizontal arms of the C-shaped cuts) and carries practical advantages that will be addressed below. First, regardless of the hinge ratio a₃/a₁, the out-of-plane deformation of the left-and right-panels (e.g., the first inner panel 24 and the second inner panel 26) is asymmetric in sign (one panel deflecting upwards, the other downwards). Similarly, as for the case of actuation under in plane tension (e.g., tension mode 20), the disclosed design presents a characteristic hinge ratio a₃/a₁ ˜0.4 at which the character of the out-of-plane displacement shifts dramatically. When the out-of-plane displacement is normalized by the sheet thickness, the mechanical amplification of the Kirigami motif 10 becomes evident, with maximal displacements several multiples of the imposed shear displacement (e.g., shear mode 22). This input-output amplification has potential for a number of mechanics-based systems, as discussed below. While FIG. 3A presents a single snapshot of the buckled configuration of these metamaterials, the subfigure charts 56 depicted in FIG. 3B present the bifurcation curves of specific Kirigami geometries that lead to that final configuration. In all cases, the shape-morphability arises from coincident pitchfork bifurcations with descending critical shear strains with descending hinge ratios. FIG. 3C illustrates a diagram 58 depicting influence of shear load direction on final deformation, according to certain aspects of the present disclosure. The relationship between the modes is also clearly depicted in the deflection charts 60 of FIG. 3D where it is seen how both deflections bifurcate and evolve along similar paths (i.e., the iso-displacement lines |u^{L}|=|u^{R}|), with increasing departure from the isolines with increasing hinge-ratios. The coupling nature of these modes could be leveraged in a number of dynamic sensing systems.

The geometric asymmetry of the motif 10 with respect to the X-Axis reveals that the response of the Kirigami units under positive and negative shear (e.g., shear mode 22) is different (see FIG. 1B). This difference with shear loading differs to that observed when in-plane tension (ε⁺) transition to compression (ε⁻) (e.g., tension mode 20 transition to compression mode 62), which changes from a Kirigami-mode (localized deflection of the panels) to a global ribbon-type mode (see FIG. 1A). Instead, when subject to alternating shear directions (e.g., shear mode 22), the Kirigami motif 10 localized response is maintained, but the orientation of the deflection inverts (e.g., from upwards to downwards). This behavior could be leveraged in a mechanical-trit application system (i.e., ternary system) whereby shearing in the positive direction, the right panel (e.g., the second inner panel 26) assumes a +1 state, by shearing back to the undeformed state it assumes a 0 state and by shearing in the negative direction it assumes a −1 state. This feature could be useful in a number shear-actuated, direction-aware applications, such as flexible strain sensors, mechanical diodes, or electromechanical switches, as further discussed below.

Finally, it is of interest to compare the activation strain (i.e., critical buckling strain) and the mode shape for the same Kirigami motif 10 when actuated under in-plane shear (γ) (e.g., the shear mode 22) or under in-plane stretch (ε). Shear buckling seems to be more easily attainable only up to a hinge ratio of a₃/a₁ ˜0.2, after which tension buckling becomes more accessible under equally imposed strains (see chart 64 in FIG. 3E). In terms of modes, as expected, shear and tension modes (e.g., shear mode 22 and tension mode 20, respectively) are substantially different from each other, which effectively expands the output space of a given Kirigami motif 10 (see FIG. 3F). Irrespective of the actual numbers, which are proper to the motif 10 and material used here, the implications of the aforementioned, from a shape-morphing application perspective are that the motif 10 may not require modification to attain a different shape, but the actuation may be modified. As such, this can be effectively harnessed in multi-modal actuators, with well-separated triggering strains.

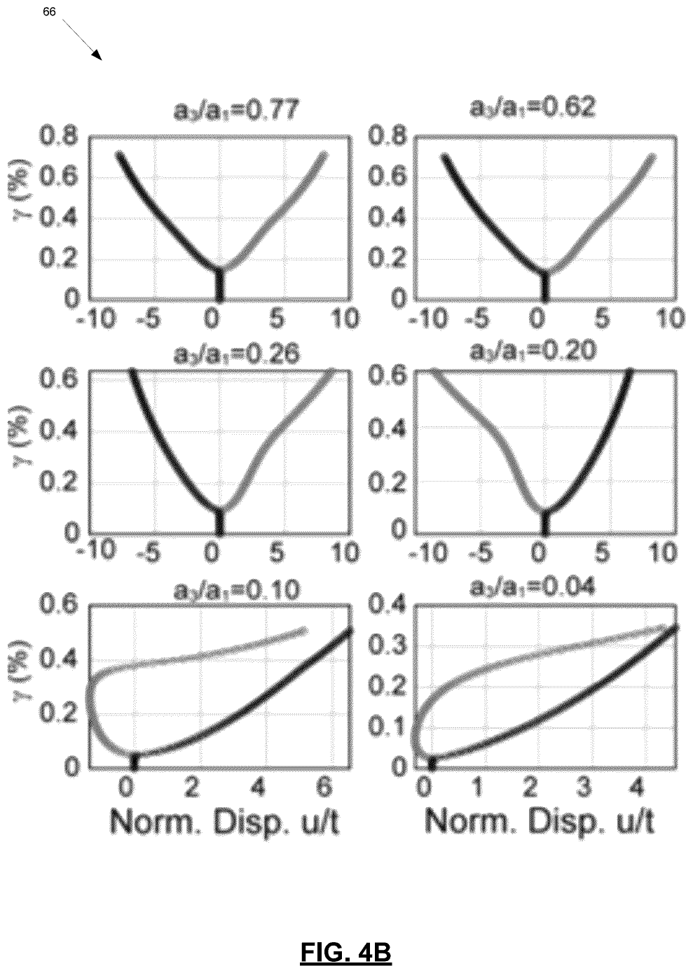

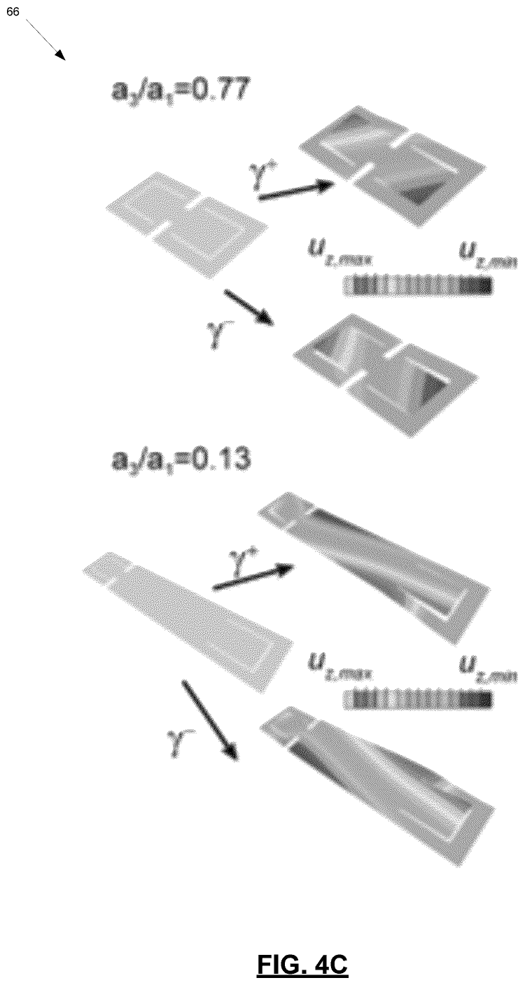

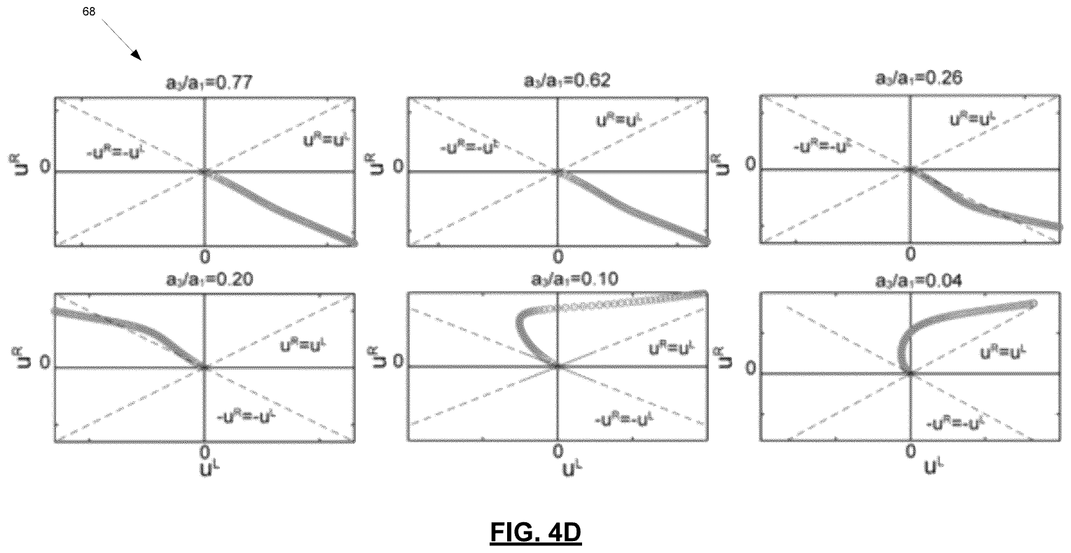

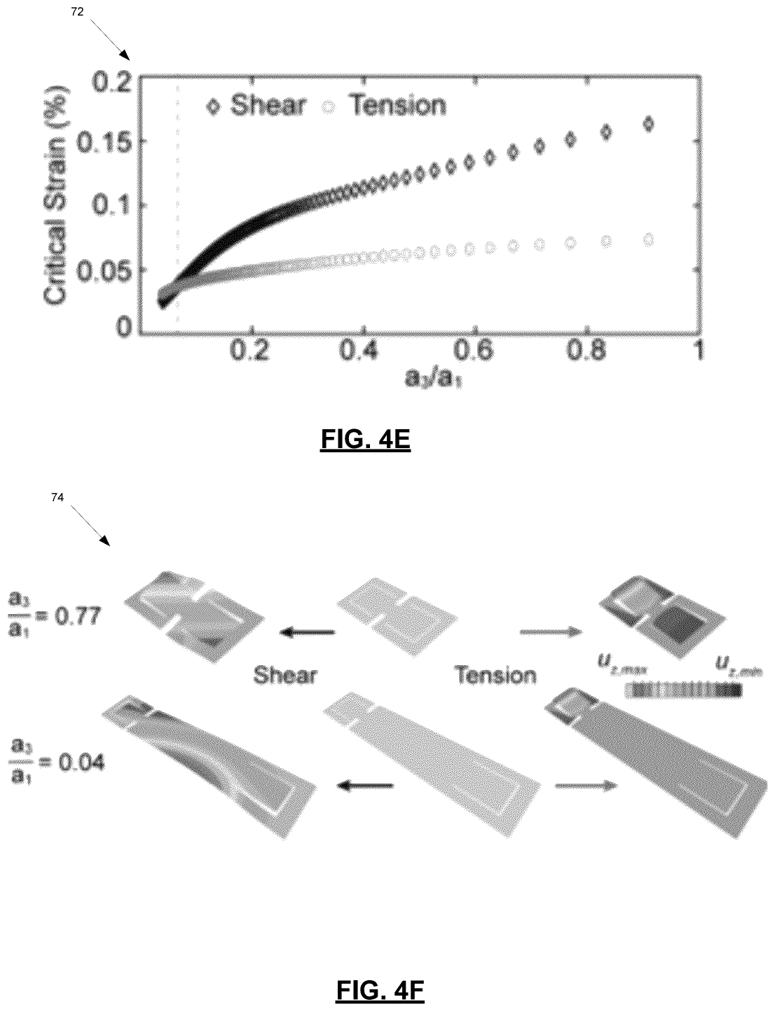

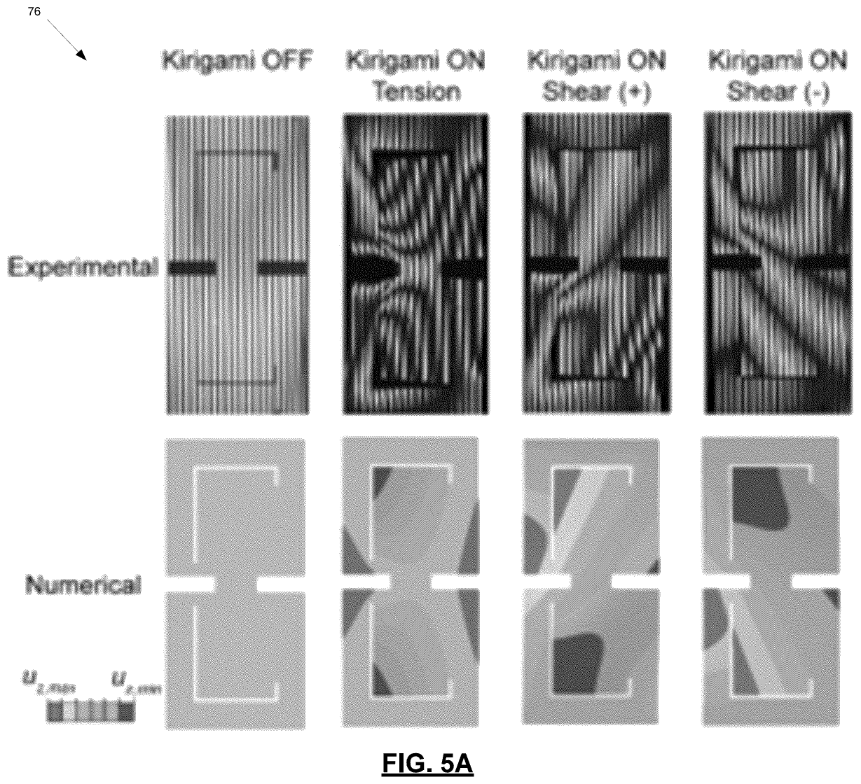

The results presented in FIGS. 4A-4F corresponds to the shear behavior of a Y-Asymmetric Kirigami motif 10. As for the X-Asymmetric case, it begins by characterizing the out-of-plane displacement with the hinge ratio a₃/a₁ taken as the bifurcation parameter (FIGS. 4A and 4B). In this context, symmetric and asymmetric modeshapes (i.e., both panels upwards, one panel upwards, and the other downwards) are uncovered, with sharp changes at ratios of a₃/a₁ ˜0.1, a₃/a₁ ˜0.25. In similarity with the X-Asymmetric case, the varying mechanical amplification of the out-of-plane displacements is also observed, though the magnitude of the amplification is larger for the present designs. Based on the single-snapshot portraits of FIG. 4A, the bifurcation landscape of Y-Asymmetric designs, though different from the X-Asymmetric ones, does not seem to hold any special value. This is however overturned when the bifurcation curves with respect to the imposed shear are analyzed. When this is the case, it is observed that the distinct regimes of the bifurcation plots with respect to the hinge ratio are accompanied by distinct bifurcation curves (see bifurcation charts 66 in FIG. 4B). Akin to X-Asymmetric Kirigami, all bifurcation curves display coincident pitchfork bifurcations, however, two interesting features stand out in the bifurcation curves in the bifurcation curves of motifs with high aspect ratio: i) the presence of kinks or changes in the slope of the bifurcation curve (see a₃/a₁=0.26 and a₃/a₁=0.20), and ii) the presence of bifurcation inversions whereby a panel that starts deflecting in a direction opposite to its counterpart, flips its direction and tends to the displacement of its counterpart panel. In this sense, the latter bifurcation type may be viewed as a more dramatic version of the gradient criticality corresponding to the former bifurcation type. Both traits are indicative of a mode-jump, which is a dynamic phenomenon whereby the buckled mode changes in response to variations of the load. These features set these systems apart from more traditional mechanical systems where the bifurcation curves are one-to-one and have a continuous first derivative. As such, they expand prospects for multiple shape-morphable states with the same motif and under the same type of loading. This behavior is also reminiscent of a mechanical tunnel-diode. Mode-coupling curves 68 presented in FIG. 4D reveal strong mode coupling in the first two regimes (a₃/a₁>0.1), whereas for the regime with a₃/a₁<0.1 the modes start off in a coupled fashion (i.e., along the iso-displacement lines), they decouple and subsequently couple again in-response to the mode jump. One can think of these features as part of a self-correcting system that could be used in control applications.

Directional dependence of Y-Asymmetric motifs manifest differently than the X-Asymmetric motif, in the sense that the deflection direction does not change, but the deflection mirrors with respect to the axis of symmetry (see diagram 70 in FIG. 4C). As such, if deflection direction is paramount in an application (e.g., panel must always flip upwards), one can envision the use of Y-Asymmetric motifs where deflection is directionally-agnostic with respect to the input. Application of this bit-type systems include fail-safe switches, and friction control surfaces, for example.

FIG. 4E illustrates a chart 72 depicting comparison of in-plane shear and in-plane tension activated Y-Asymmetric Kirigami. Comparison of buckling strains and modes for tension and shear present similar trends as the ones reported for the X-Asymmetric motifs. Shear buckling seems to be more mechanically favorable up to hinge-ratios of a₃/a₁ ˜0.07, from which tension buckling begins to be more easily attainable. The diagram 74 in FIG. 4F evinces how the output and design space of Kirigami can be enlarged simply by changing the actuation modality.

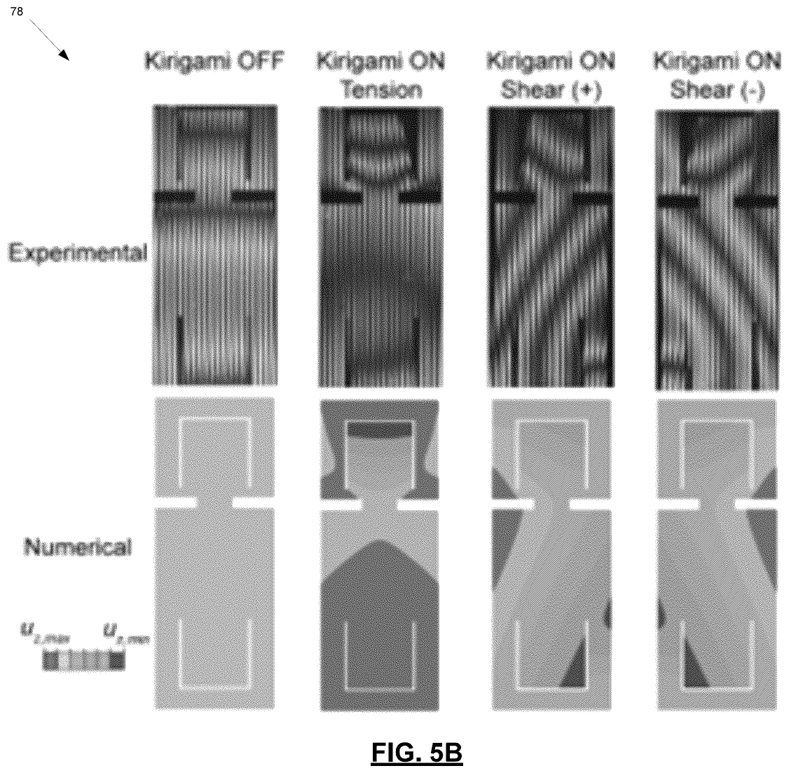

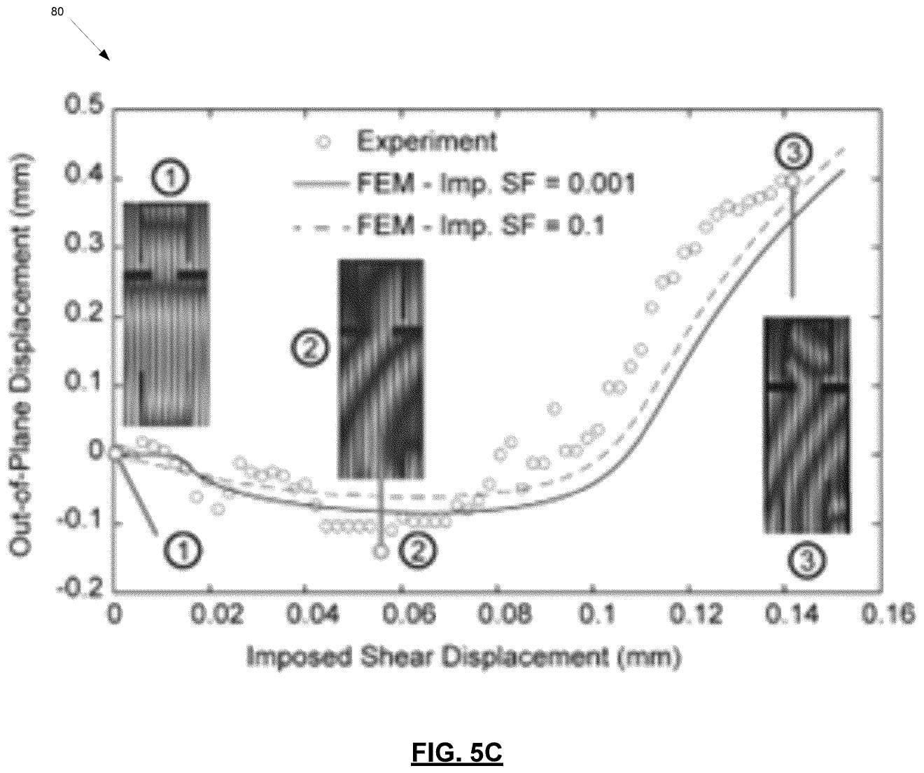

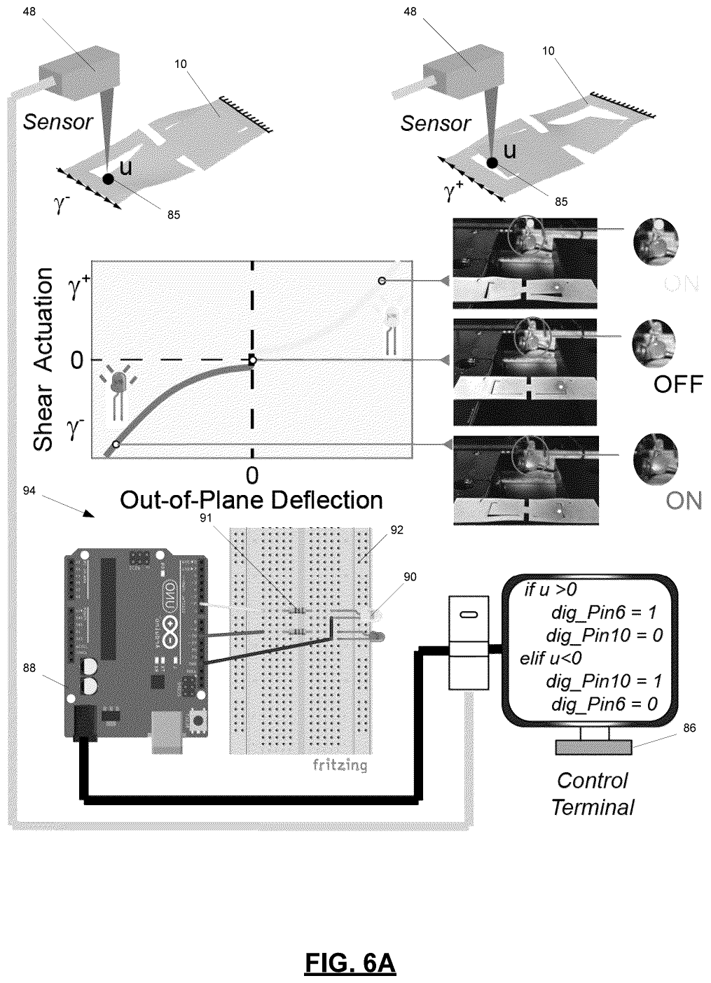

Experimental validation is performed in a dual fashion. First, qualitative comparison is pursued for the buckled mode shapes of two geometries of interest (one with pronounced X-Asymmetric characteristics a₃/a₁=0.18, and the other one with pronounced Y-Asymmetric features a₃/a₁=0.09) subject to tension and both positive and negative shear. FIGS. 5A and 5B, in first comparison diagram 76 and in second comparison diagram 78, respectively, present the comparison between the numerically predicted out-of-plane displacements and the displacements obtained in the tabletop shear experiments using full-field shadow moiré imaging technique. As can be seen from FIGS. 5A and 5B, very good agreement exists between the moiré interferograms and the contour plots from the finite element analysis. The expansion of the shape-morphing capabilities of these Kirigami motifs by simply allowing for different actuation modality is evident by comparing the tension and shear interferograms. In both cases, markedly different 3D configurations are attained. Furthermore, the inversion of the displacement under inverted shear is evident for the X-Asymmetric case, whereas the mirroring effect without displacement inversion is also evident for the Y-Asymmetric case.

Quantitative comparison was pursued for a particular Y-Asymmetric Kirigami motif 10 with predicted mode jump behavior (i.e., motif with a₃/a₁=0.09). For this case, the beam of the laser displacement sensor 46 described above was used to monitor the displacement change of a point close to the edge of the short panel (in correspondence to the point tracked numerically, see schematic in FIG. 4A). The results are presented in a diagram 80 in FIG. 5C along with numerical results considering two different degrees of imperfection (i.e., the parameter SF is the scale factor applied to the geometric imperfection from a linear buckling analysis). Numerical results with imperfections are deemed adequate given the initial imperfection that these high-aspect ratio motifs usually have (see moiré interferogram), which stem from the manufacturing process. Good agreement is observed between the experimentally obtained deflection and the numerically predicted one, with the bifurcation inversion (i.e., mode jump) being detected. The mode jump is also made evident by the sharp change in the contour plots presented in the inset of FIG. 5C. Existing discrepancies between the experimental and numerical values could also stem from the finite spot size of the laser, its resolution, and the test conditions (i.e., fluttering of the Kirigami panels).

As described above, the use of shear-actuation (e.g., shear mode 22) with these mechanical meta-atoms adds new dimensions to their applicability, both in terms of the environment/stimuli (i.e., the mode of actuation) and the shape-morphability (i.e., different buckled shapes compared to those in tension). Beyond their distinct shape-changing characteristics, these Kirigami units (e.g., the Kirigami motif 10) offer very clear points of regime change and display out-of-plane displacements which are several multiples higher than the corresponding actuation displacements. Added to the fact that Kirigami behavior is known to be scale-independent and material-independent, these translates into the uncovered metamaterials being ideal candidates for multimodal, multidirectional electromechanical switches and sensors.

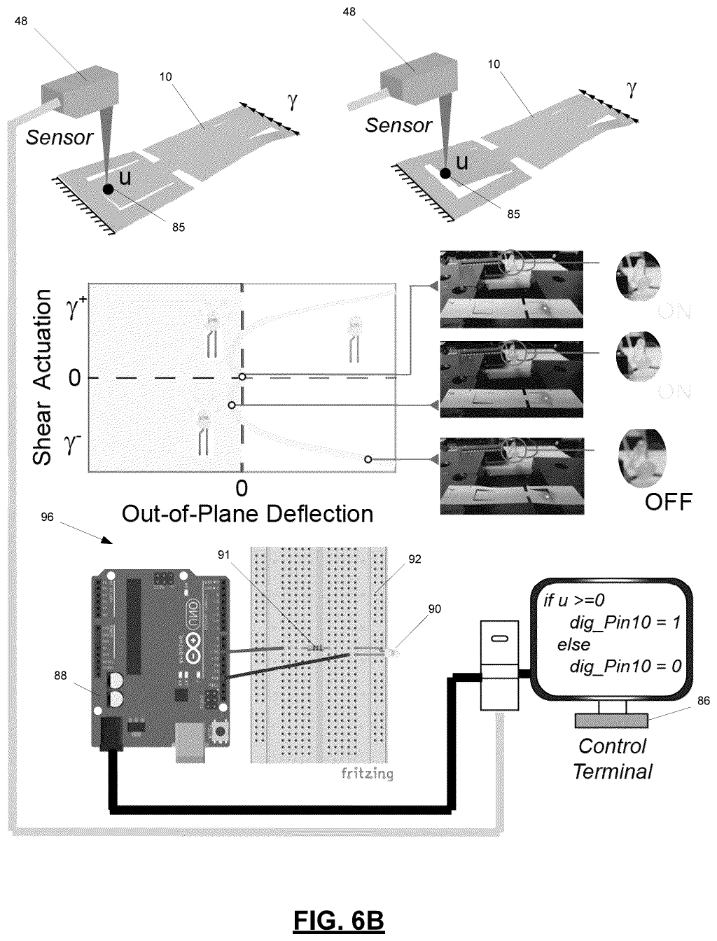

With reference to FIGS. 6A and 6B, depicting first switch diagram 82 and second switch diagram 84, respectively, two simple electromechanical switches are constructed. The switch setup builds on the setup previously described above and outlined in FIGS. 2A and 2B, where the laser sensor (e.g., the red laser sensor 48) is positioned above the Kirigami motif 10 and used to take measurements at a spot (e.g., tracker node 85) on one of the bifurcating panels. Selection of the tracking spot for these applications is not casual but is related to the selection of the tracking node of the preceding sections. Along these lines, even though out-of-plane displacements could be higher in the corner nodes of the panels, robustness in terms of laser positioning, suggest a tracker node along the center line is better (i.e., better spot size to reflecting area ratio). The reading from the laser displacement sensor 46 is sent to a control terminal 86 (i.e., a PC), which is connected to, for example, an Arduino UNO microcontroller board (e.g., microcontroller board 88)92. Matlab R2022b Instrument Control Toolbox, for example, was used to program the control logic between the components. The board's digital pins are used to establish a connection with a simple circuit consisting of a number of light-emitting diodes 90 (i.e., LEDs) and 220Ω resistors (e.g., resistors 91) mounted on an adjacent breadboard 92.

Using the above-described setup, two different switches are envisaged. The first switch 94 leverages the conventional pitchfork bifurcation of an X-Asymmetric Kirigami and its directional dependence, as shown in FIG. 6A. Using these characteristics, which resemble that of a diode, a switch with three states is created. In the 0 state (no deflection) the LEDs are OFF, in the +1 state (positive shear, panel upwards) the yellow LED is turned ON, and in the −1 state (negative shear, panel downwards) the red LED is turned ON. The second switch 96 (see FIG. 6B) leverages the pitchfork bifurcation with inversion of a Y-Asymmetric Kirigami under shear. Harnessing this feature, a two-state switch with a threshold can be created, as shown in FIG. 6B. In the default state of this system, the +1 state, the red LED is turned ON. Upon shear actuation, as the panel bifurcates in one direction the red LED remains ON until the mode jumps and the panel deflects downwards to the 0 state where the red LED is turned OFF. As such, the created switch has a delay with respect to actuation, as the Kirigami must be sufficiently sheared before it inverts and deactivates the bulb (e.g., LED 90).

Such demonstrations validate the idea that Kirigami undergoing shear may be used as a very straightforward switching technology. Thinking beyond the mere switching of lights, the first switch 94 case may be used to detect motion, where any forward motion will trigger the light (or other connected system) and so may be used as a start gate. The second switch 96 deactivates after a set distance of travel is reached. Accordingly, it may be conceived as an end limiter, which activates once the device has reached the end of its travel length. Similarly, the second switch 96 could be further applied in warning systems where the panel deflection while in the +1 state (as panel goes upwards) is made proportional to an audible signal that warns the user that the system is close to shutdown. If the input is not corrected (i.e., shear actuation not reduced, then the switch fails and shuts the system down). Both applications could add to similar applications in tension-activated Kirigami, thus effectively behaving as multimodal switches.

While the above description so far has considered these applications directly, there is another aspect of this application setup which is important to consider. The shear displacements undergone here are rather small (order of ˜10 micrometers). These displacements require a system with very high resolution to be measured accurately, which poses a problem for electrical or optical measurement systems as this typically correlates with a high cost. Conversely, the out-of-plane displacements are much larger (several multiples of the actuation) and therefore are much easier to measure well. This effect is implicitly demonstrated in the present disclosure, where a tabletop displacement sensor incapable of resolving shear displacements (due to magnitude not to the shear character) can effectively resolve the ensuing out-of-plane deformations. Considering the inverse case, if the bifurcation and coupling curves of the system are known, measurement of the panel deflections can inform on the shear displacement imposed. In other words, these systems act as multimodal mechanical amplifiers (i.e., small mechanical inputs converted to much larger mechanical outputs), which could be exploited in various measurement and sensing systems.

The present disclosure focuses beyond the response of Kirigami to in-plane stretching and instead focuses on the response of a simple Kirigami meta-atom to shear loading. By mapping the instability landscape of Kirigami metamaterials under shear, a rich design and output space, which effectively adds to the already rich spaces found when subject to stretching, is provided. The distinct out-of-plane morphologies under different loading regimes could be used in multi-modal, shape-programmable applications that respond differently to different stimuli. Inverse design of these systems, using machine learning techniques for instance, could be further investigated by now adding a new component (i.e., the load type) to the feature space. Beyond the directionally aware, shape-change capability, understood as a mapping from one configuration to the other, study of shear bifurcation curves reveal an exotic bifurcation landscape with mode jump features that could be leveraged in a number of variegated applications, two of which are described above.

The present disclosure highlights the potential of considering other loading approaches for Kirigami systems. Natural extensions for future work include investigating responses under other fundamental loadings or under combined loadings. Similarly, even though focus has been on a single motif, the potential incorporation of new loading modalities could also be exploited in other Kirigami motifs, and are within the scope of the present disclosure. As such, it is expected that by expanding the displacement responses observed within this material platform, more potential use cases will be enabled. Similarly, integration of these multi-modal systems at different scales and into more complex architectures like soft robots and environmentally-aware (stimuli responsive) systems holds considerable promise on account of Kirigami's demonstrated versatility.

As noted from the above description, the disclosed technology can be utilized in a wide range of various applications such as, but not limited to, beam steering devices (morphable targets to steer light beams, for example in Lidar Applications), solar sails (solar sails are usually made of a single canvas, much like the sail of ship, that has to be maneuvered to be steered. With our technology, solar sails could be made of Kirigami tiles, which modulate the force vector generated by impinging photons), solar concentrators (Fresnel concentrators from linear Kirigami arrays or parabolic Kirigami could be used to reflect light with tunable foci. They could replace much bulkier counterparts, with the added benefit of being foldable), solar panels (similar to solar concentrators-A 2D array of our Kirigami units could be used for single or dual axis solar tracking), surfaces for solid friction and haptic devices (surface roughness is a key component in friction; As such, the ability to generate different shapes, with varying degrees of prominence, could be used to vary the degree of smoothness and texture in surfaces; They could also be used in haptic devices to generate different textures on-demand; They could also be used for wettability), surfaces for aero-/hydro-dynamic drag control (many examples from the natural world use surface control to affect flow parameters of surrounding fluid; For example, sharks have ribbed scales that protrude from the skin with varying angle for boundary layer control; Our Kirigami samples could be implemented in similar skins in airplanes, ships, or other vehicles operating in fluid domains), turbulators (heat exchangers are often equipped with structural elements with the sole purpose of making fluid passage more turbulent; These are often strips of metal with curves and protrusions aimed at altering fluid motion; The ability of our Kirigami to be assembled in strip, could be used in morphable turbulators), actuators (tilting panels in our Kirigami platform could be used to actuate different objects; For example, they could be used as variable angle sorting paddles in conveyor systems, grippers for capturing and releasing objects, paddles for generating fluid motion, valves, etc.), mechanical amplifiers (an important aspect of Kirigami is their ability to generate large displacements with small displacement input; This makes them very good candidates in applications where a mechanical quantity (e.g., displacement) needs to be amplified for measurement or sensing), strain sensors (small strain applied at the edges of Kirigami could be measured by measuring the out-of-plane displacement of the panels (provided the relationship between input actuation and output displacement, i.e., the bifurcation curve, is known); As such they could be used in strain sensors, but also in other types of sensors that affect the mechanical response of Kirigami (e.g., mass sensors)), electromechanical switches (tension and shear triggered Kirigami could be used as electromechanical switches when coupled with electronic measurement systems; For example, the shear Kirigami was demonstrated to be useful as a switch with a threshold (much like a diode) when coupled with a laser displacement sensor), cryptography (the dynamic properties of the motion of the panels when Kirigami is excited dynamically can be used in cryptography applications where chaos or certain periodic motions are sought-after), functionalized morphable substrates (all of the above can be further enhanced by functionalizing Kirigami surfaces with chemical coatings and physical devices mounted on them; For example, our Kirigami units can be equipped with split ring resonators to affect electromagnetic waves by varying their orientation with respect to incoming waves (as opposed to static counterparts); Integration of other elements within the Kirigami substrate could open the window for environmentally responsive, active Kirigami, responding to heat, light, pH, etc.), and other appropriate applications.

To illustrate the interchangeability of hardware and software, items such as the various. illustrative blocks, modules, components, methods, operations, instructions, and algorithms have been described generally in terms of their functionality. Whether such functionality is implemented as hardware, software or a combination of hardware and software depends upon the particular application and design constraints imposed on the overall system. Skilled artisans may implement the described functionality in varying ways for each particular application.

As used herein, the phrase “at least one of” preceding a series of items, with the terms “and” or “or” to separate any of the items, modifies the list as a whole, rather than each member of the list (e.g., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

What is claimed is:

1. A Kirigami motif comprising:
a substrate comprising a plane; and
inner panels defined by geometric cuts disposed through the substrate, the geometric cuts comprising fixed geometric parameters, wherein the substrate is configured for controlled actuation in-plane, with respect to the plane, to control out-of-plane deformation of the inner panels.

2. The Kirigami motif of claim 1, wherein the substrate is a thin rectangular sheet and the geometric cuts define a first C-shaped geometry and a second C-shaped geometry separated by vertical orthogonal notches.

3. The Kirigami motif of claim 1, wherein the controlled actuation is responsive under in-plane loading modes, the in-plane loading modes comprising tension and shear.

4. The Kirigami motif of claim 1, wherein the controlled actuation of the substrate is based on programmable instructions.

5. The Kirigami motif of claim 1, wherein the out-of-plane deformations are X-Asymmetric.

6. The Kirigami motif of claim 1, wherein the out-of-plane deformations are Y-Asymmetric.

7. The Kirigami motif of claim 1, wherein the substrate is configured for controlled actuation to control out-of-plane deformation of the inner panels to operate as grippers.

8. The Kirigami motif of claim 1, wherein the substrate is configured for controlled actuation to control out-of-plane deformation of the inner panels wherein a first inner panel of the inner panels to deflects upward and a second inner panel of the inner panels to deflects downwards.

9. The Kirigami motif of claim 1, wherein the substrate is configured for controlled actuation to control out-of-plane deformation of the inner panels wherein a first inner panel of the inner panels is configured to assume a +1 state by shearing in a positive direction, to assume a 0 state by shearing to an undeformed state, and to assume a −1 state by shearing in a negative direction.

10. The Kirigami motif of claim 1, wherein the substrate is configured for controlled actuation to control out-of-plane deformation of the inner panels under dynamic conditions.

11. A device comprising:
at least one Kirigami motif, where in the at least one Kirigami motif comprises a substrate comprising a plane; and
inner panels defined by geometric cuts disposed through the substrate, the geometric cuts comprising fixed geometric parameters, wherein the substrate is configured for controlled actuation in-plane, with respect to the plane, to control out-of-plane deformation of the inner panels.

12. The device of claim 11, wherein the substrate is a thin rectangular sheet and the geometric cuts define a first C-shaped geometry and a second C-shaped geometry separated by vertical orthogonal notches.

13. The device of claim 11, wherein the controlled actuation is responsive under in-plane loading modes, the in-plane loading modes comprising tension and shear.

14. The device of claim 11, wherein the controlled actuation of the substrate is based on programmable instructions.

15. The device of claim 11, wherein the out-of-plane deformations are X-Asymmetric.

16. The device of claim 11, wherein the out-of-plane deformations are Y-Asymmetric.

17. The device of claim 11, wherein the substrate is configured for controlled actuation to control out-of-plane deformation of the inner panels to operate as grippers.

18. The device of claim 11, wherein the substrate is configured for controlled actuation to control out-of-plane deformation of the inner panels wherein a first inner panel of the inner panels to deflects upward and a second inner panel of the inner panels to deflects downwards.

19. The device of claim 11, wherein the substrate is configured for controlled actuation to control out-of-plane deformation of the inner panels wherein a first inner panel of the inner panels is configured to assume a +1 state by shearing in a positive direction, to assume a 0 state by shearing to an undeformed state, and to assume a −1 state by shearing in a negative direction.

20. The device of claim 11, wherein the substrate is configured for controlled actuation to control out-of-plane deformation of the inner panels under dynamic conditions.
